(19) United States
(12) Patent Application Publication
(10) Pub. No.: US 2021/0150232 A1
(43) Pub. Date: May 20, 2021

(54) METHOD AND DEVICE FOR DETECTING A STATE OF SIGNAL INDICATOR LIGHT, AND STORAGE MEDIUM

(71) Applicant: Shenzhen Sensetime Technology Co., Ltd., Shenzhen (CN)

(72) Inventor: Sichang Su, Shenzhen (CN)

(73) Assignee: Shenzhen Sensetime Technology Co., Ltd., Shenzhen (CN)

(21) Appl. No.: 17/159,352

(22) Filed: Jan. 27, 2021

Related U.S. Application Data
(63) Continuation of application No. PCT/CN2020/091064, filed on May 19, 2020.

(30) Foreign Application Priority Data
May 28, 2019 (CN) 201910450394.3

(51) Int. Cl. G06K 9/00; G06K 9/62; G06K 9/46; B60W 50/14; B60W 60/00; B60W 30/14

(52) U.S. Cl. CPC G06K 9/00825; G06K 9/6223; G06K 9/4652; G06K 9/628; B60W 30/143; G06K 9/6255; B60W 50/14; B60W 60/001; G06K 9/627

(57) ABSTRACT

The present disclosure relates to a method and apparatus for detecting a state of a signal indicator light, and a method and apparatus for driving control. The method for detecting a state of a signal indicator light includes: detecting a target region in a target image and determining first feature values of pixels within the target region, where at least one signal indicator light having different display states is present in the target region; clustering the pixels within the target region based on the first feature values to obtain a plurality of class groups for the pixels; and determining a display state of the signal indicator light based on the obtained plurality of class groups.

### CROSS-REFERENCE TO RELATED APPLICATIONS

The present application is a continuation of and claims priority under 35 U.S.C. 120 to PCT Application. No. PCT/CN2020/091064, filed on May 19, 2020, which claims priority to Chinese Patent Application No. 201910450394.3 filed with the Chinese Patent Office on May 28, 2019 and entitled “Method and Device for Detecting a State of Signal Indicator Light, Driving Method and Device”. All above-referenced priority documents are incorporated herein by reference in their entireties.

### TECHNICAL FIELD

The present disclosure relates to a field of computer vision, and in particular, to a method and apparatus for detecting a state of a signal indicator light, and a method and apparatus for driving control.

### BACKGROUND

During autonomous driving or aided driving, states of traffic lights at junctions need to be detected. An autonomous vehicle needs to detect locations and states of traffic lights in real time under road conditions with various disturbing environmental factors to make optimal path planning. The autonomous vehicle can capture images of road scenes with a camera as a sensor to detect the traffic lights in real time.

### SUMMARY

Embodiments of the present disclosure provide a solution for detecting a state of a signal indicator light.

In a first aspect of the present disclosure, there is provided a method for detecting a state of a signal indicator light, comprising:

detecting a target region in a target image and determining first feature values of pixels within the target region, wherein at least one signal indicator light having different display states is included in the target region;

clustering the pixels within the target region based on the first feature values to obtain a plurality of class groups for the pixels; and

determining a display state of the signal indicator light based on the obtained plurality of class groups.

According to a second aspect of the present disclosure, there is provided a method for driving control, comprising:

capturing a road image by an image capturing device on intelligent driving equipment;

subjecting the road image as the target image to the method for detecting a state of a signal indicator light according to any of the first aspect, to obtain the display state of the signal indicator light in the road image; and

generating and outputting a control instruction for controlling the intelligent driving equipment based on the display state of the signal indicator light in the road image to control the intelligent driving equipment.

In a third aspect of the present disclosure, there is provided an apparatus for detecting a state of a signal indicator light, comprising:

a detection module, configured to detect a target region in a target image and determine first feature values of pixels within the target region, wherein at least one signal indicator light having different display states is present in the target region;

a clustering module, configured to cluster the pixels within the target region based on the first feature values to obtain a plurality of class groups for the pixels; and

a determination module, configured to determine a display state of the signal indicator light based on the obtained plurality of class groups.

In a fourth aspect of the present disclosure, there is provided an apparatus for driving control, comprising:

an image capturing device, mounted on intelligent driving equipment and configured to capture a road image;

a signal indicator light state detecting module, configured to subject the road image as the target image to the method for detecting a state of a signal indicator light according to any of the first aspect, to obtain the display state of the signal indicator light in the road image; and

a control module, configured to generate and output a control instruction for controlling the intelligent driving equipment based on the display state of the signal indicator light in the road image to control the intelligent driving equipment.

In a fifth aspect of the present disclosure, there is provided an electronic device, comprising:

a processor; and

a memory configured to store processor-executable instructions;

wherein the processor is configured to perform the method according to any one of the first aspect, or the method according to any one of the second aspect.

In a sixth aspect of the present disclosure, there is provided a computer readable storage medium having computer program instructions stored thereon, wherein the computer program instructions, when executed by a processor, implement the method according to any one of the first aspect, or the method according to any one of the second aspect.

In a seventh aspect of the present disclosure, there is provided a computer program including computer readable codes, wherein when the computer readable codes are running on an electronic device, such codes are executed by a processor of the electronic device for implementing the method according to any one of the first aspect, or the method according to any one of the second aspect.

It should be understood that the foregoing general description and the following detailed description are merely exemplary and explanatory rather than limitative of the present disclosure.

Other features and aspects of the present disclosure will be clear from the following detailed description of exemplary embodiments with reference to the accompanying drawings.

### BRIEF DESCRIPTION OF THE DRAWINGS

The accompanying drawings, which are incorporated herein and form a part of the specification, illustrate embodiments of the present disclosure and, together with the specification, serve to explain the technical solutions of the present disclosure.

FIG. 1 shows a flow chart of a method for detecting a state of a signal indicator light according to an embodiment of the present disclosure.

FIG. 2 shows a flow chart of step S30 in a method for detecting a state of a signal indicator light according to an embodiment of the present disclosure.

FIG. 3 shows a flow chart of obtaining a reference feature value in a method for detecting a state of a signal indicator light according to an embodiment of the present disclosure.

FIG. 4 shows a flow chart of step S34 in a method for detecting a state of a signal indicator light according to an embodiment of the present disclosure.

FIG. 5 shows another flow chart of step S34 in a method for detecting a state of a signal indicator light according to an embodiment of the present disclosure.

FIG. 6 shows a schematic structural diagram of signal indicator lights according to an embodiment of the present disclosure.

FIG. 7 shows a flow chart of a method for driving control according to an embodiment of the present disclosure.

FIG. 8 shows a block diagram of an apparatus for detecting a state of a signal indicator light according to an embodiment of the present disclosure.

FIG. 9 shows a block diagram of an apparatus for driving control according to an embodiment of the present disclosure.

FIG. 10 shows a block diagram of an electronic device according to an embodiment of the present disclosure.

FIG. 11 shows another block diagram of an electronic device according to an embodiment of the present disclosure.

### DETAILED DESCRIPTION

Hereinafter, various exemplary embodiments, features and aspects of the present disclosure will be described in detail with reference to the accompanying drawings. Same reference numbers denote components having the same or similar functions throughout the drawings. While various aspects of embodiments are shown in the drawings, the drawings are not necessarily drawn to scale unless otherwise specified.

As used herein, the word “exemplary” means “serving as an example, embodiment, or illustration”. Any embodiment described herein as “exemplary” is not necessarily to be construed as preferred or advantageous over other embodiments.

As used herein, the term “and/or” is merely descriptive of a relationship of associated listed items, denoting that there may be three cases. For example, A and/or B may denote including A alone, including both A and B, and including B alone. In addition, the term “at least one”, as used herein, denotes any one of a plurality or any combination of at least two of the plurality. For example, at least one of A, B and C may denote any one or a plurality of elements selected from a set composed of A, B and C.

In addition, numerous specific details are given in specific embodiments described below to better illustrate the present disclosure. A person skilled in the art will understand that present disclosure may be practiced without some specific details. In some examples, methods, means, components and circuits well known to those skilled in the art have not been described in detail so as not to unnecessarily obscure the subject matter of the present disclosure.

An embodiment of the present disclosure provides a method for detecting a state of a signal indicator light, which can detect a display state of a signal indicator light in a target image. Wherein, the method for detecting a state of a signal indicator light provided by the embodiment of the present disclosure can be used in any image capturing and image processing devices, for example, in a video camera, a camera, a cellphone, a computer, a PDA (Personal Digital Assistant), a smart watch, a smart bracelet, or a server, or in a robot, an intelligent driving device, a guiding device for the blind, etc. The method provided by the embodiment of the present disclosure can be implemented by any device as long as it can perform image capturing or processing, which is not specifically limited in the present disclosure. The present disclosure can be applied to scenarios such as indicator light state recognition and detection. For example, in autonomous driving, the states of traffic lights can be detected to realize path planning, navigation, etc. Specific application scenarios are not limited in the present disclosure.

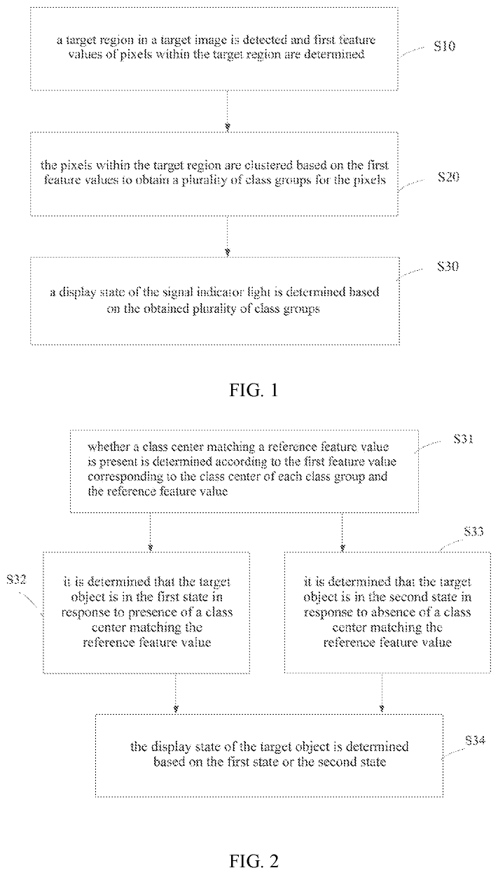

FIG. 1 shows a flow chart of a method for detecting a state of a signal indicator light according to an embodiment of the present disclosure. The method for detecting a state of a signal indicator light may include steps of:

S10: a target region in a target image is detected and first feature values of pixels within the target region are determined, where at least one signal indicator light having different display states is present in the target region.

As described above, the method for detecting a state of a signal indicator light provided in the embodiment of the present disclosure can implement detection of a display state of a signal indicator light (hereinafter referred to as a target object) in a target image, where the target image can be obtained first. In some possible embodiments, the target image is an image captured by an image capturing device. For example, an image capturing device such as an automobile data recorder can be disposed in autonomous driving or aided driving equipment such as an automobile and a flight vehicle to capture a traveling record image, which can be taken as the target image in the embodiment of the present disclosure. Alternatively, the target image can be sampled from received video images, or received from other devices, which is not specially limited in the present disclosure.

In some possible embodiments, after the target image is obtained, the target region where the target object is present in the target image can be detected through step S10, where the target object may include a signal indicator light, and the signal indicator light may include signal indicator lights of going straight and turning for guiding traveling directions, or include signal indicator lights for guiding stopping, traveling and waiting, or include signal indicator lights for indicating operating states of various instruments and equipment. FIG. 6 shows a schematic structural diagram of signal indicator lights according to an embodiment of the present disclosure, where the types of different signal indicator lights are illustrated by way of example, such as traffic lights arranged longitudinally, traffic lights arranged transversely, or direction indicator lights. The target object illustrated in FIG. 6 may include three indicator lights. In the embodiment of the present disclosure, the number of indicator lights may be one or more, which is not specifically limited here. In addition, a signal indicator light may have different display states, for example, on or off, or may have different colors when it is on, for example, at least one of red, amber and green, or may include other colors or other display states in other embodiments. In the embodiment of the present disclosure, the description is made by taking as an example that the target object is a signal indicator light. In other embodiments, any target object that has different display states such as different colors or different levels of brightness can be regarded as the target object in the embodiment of the present disclosure.

In some possible embodiments, the detection of the target object and the target region where the target object is present can be performed by an image recognition algorithm (non-neutral network detection method). Alternatively, the detection of the target object and the target region where the target object is present can be performed by training a neutral network for recognizing the target object, where the neural network can be a convolutional neural network. Alternatively, the target region where the target object is present can be determined by means of a received box selecting operation. For example, a touch control (i.e., box selecting operation) input by a user can be received by an input component, and then the target region where the target object is present can be determined based on a region box-selected by the touch control operation. The foregoing is merely exemplary description, and the target region where the target object is present can also be determined by other means in other embodiments, which is not specifically limited in the present disclosure.

After the target region where the target object is present in the target image is determined, first feature values corresponding to a plurality of pixels in the target region can be obtained. The first feature value can represent the pixel value of a pixel, which specifically can be a feature value of at least one color channel corresponding to a pixel. If the target image in the embodiment of the present disclosure can be an RGB image (a color image), the obtained first feature value of the pixel can be a color value of a pixel in the target region. The color value is a corresponding value of a color in a different color mode. The color mode is a mode where a color is shown in a digital form, or a mode for recording image colors. Currently common color modes include: RGB mode, CMYK mode, HSB mode, Lab color mode, Bitmap mode, Grayscale mode, Indexed color mode, Duotone mode and Multi-channel mode, etc. Therefore, in the RGB mode, the color value may include an R value, a G value and a B value. The RGB mode is also the most commonly used color mode at present. The following examples only take the RGB mode as an example. The method for detecting a state of a signal indicator light with other color modes is similar to the method for detecting a state of a signal indicator light with the RGB mode and will not be reiterated here. In addition, when the target image is an image in other form, the image in other form can be converted into an RGB image through space conversion. For example, an image in YUV form is converted into an image in RGB form, and then the first feature values of pixels can be obtained. The manner of image conversion is not specifically limited in the embodiment of the present disclosure.

In some possible embodiments, the first feature values of a plurality of pixels within the target region can be normalized color values. In other words, after the color values (R values, G values and B values) of a plurality of pixels within the target region of the target image are obtained in the embodiment of the present disclosure, the obtained R values, G values and B values can be normalized, so that noise can be reduced and the difference of the first feature value due to the introduction of noise can be reduced, thereby improving the clustering accuracy and the display accuracy of the display state. The normalization approach may include dividing each of the R values, G values and B values by a standard value, thereby obtaining normalization results of the R values, G values and B values. The standard value can be determined as required, and generally can be determined according to the grayscales of a plurality of pixels of the target image. For example, the maximum pixel value of the target image can be determined as the standard value. For example, if the RGB of a pixel in the target region is expressed as (255, 0, 0) and the standard value is 255, the normalization result can be (1, 0, 0).

S20: the pixels within the target region are clustered based on the first feature values to obtain a plurality of class groups for the pixels.

In the embodiment of the present disclosure, under the circumstance that the first feature values of a plurality of pixels within the target region are obtained, the plurality of pixels can be clustered based on the obtained first feature values to obtain class groups of different color states.

In some possible embodiments, the first feature values of a plurality of pixels can be mapped onto a three-dimensional space corresponding to colors values. Taking a color value being RGB as an example, the first feature values of a plurality of pixels can be mapped into RGB three-dimensional space, and RGB values can be regarded as coordinate points in the RGB three-dimensional space. For example, for a pixel having the first feature value (1, 0, 0), it can be located on an R axis and its coordinate value on the R axis is 1. Similarly, the position of each pixel in the RGB space can be obtained, and then a plurality of pixels can be clustered based on the positions of a plurality of first feature values in the RGB space.

In some possible embodiments, clustering of a plurality of pixels can be performed by a K-means clustering algorithm. According to the K-means clustering algorithm, K (K is an integer greater than 1) objects (first feature values) can be randomly selected as initial centers of clustering from the first feature values of a plurality of pixel points within the target region, and the number of the centers of clustering is the same as the preset number of class groups. Next, a distance between each object and each of the plurality of initial centers of clustering is calculated, and each object is assigned to the closest center of clustering. A center of clustering and objects assigned to it represent a cluster (class group). Once all objects are assigned, the center of clustering of each cluster may be recalculated according to existing objects in the cluster. This process will be repeated continuously until a termination condition is satisfied. The termination condition can be that no (or the minimum number of) objects are reassigned to different clusters and no (or the minimum number of) centers of clustering change. In this manner, the clustering of a plurality of pixels can be completed and a plurality of class groups of preset number can be obtained. The class centers (center of clustering) of the class groups can be determined while a plurality of class groups are obtained after the K-means clustering.

In this embodiment of the present disclosure, the pixels having approximate distances of the first feature values can be assigned to a class group (cluster) by the above clustering, and this process can realize clustering of pixels having the same color.

S30: a display state of the signal indicator light is determined based on the obtained plurality of class groups.

As described above, the clustering of pixels having the same color can be performed through step S20 in this embodiment of the present disclosure, and different class groups obtained by clustering can be expressed as clusters of pixels having different colors. Therefore, the display state of the target object in the target region can be determined according to the color represented by a cluster, wherein the target object can be a signal indicator light.

Correspondingly, the display state of the target object in this embodiment of the present disclosure may include a first state and a second state. The first state is a state where there is a signal indicator light that is on, while the second state is a state where no signal indicator light is on, and in the first state, the color of the indicator light that is on can be further determined.

FIG. 2 shows a flow chart of step S30 in a method for detecting a state of a signal indicator light according to an embodiment of the present disclosure, wherein determining the display state of the target object based on the obtained plurality of class groups may include steps of:

S31: whether a class center matching a reference feature value is present is determined according to the first feature value corresponding to the class center of each class group and the reference feature value.

In some possible embodiments, reference feature values for a plurality of color states can be set. Similarly, each reference feature value can have a color value of a corresponding value, such as an RGB value. Besides, the reference feature value can be mapped onto the color value space, so that whether the class center of a class group matches the reference feature value can be determined based on the distance between the color value corresponding to the reference feature value and the class center of the class group. In the case that the target object is a signal indicator light, the set reference feature value may include: a reference feature value of a red state, a reference feature value of an amber state and a reference feature value of a green state. The reference feature value can be expressed as a coordinate point in RGB space and its coordinate value is a corresponding RGB value.

Whether the class centers of a plurality of class groups obtained by clustering match the reference feature value, i.e., whether the colors of corresponding class group matches the color corresponding to the reference feature value can be determined by comparing the class centers with the reference feature value.

In some possible embodiments, when the distance between a class center and a reference feature value is less than a distance threshold, it can be determined that the class center matches the reference feature value, i.e., the color of the class group corresponding to the class center matches the color corresponding to the reference feature value. In other words, a high-brightness display state of the color can be present in the target region, for example, a state where an indicator light is on. If there is no reference feature value matching the class centers of all class groups, i.e., the distance between each class center and each of a plurality of reference feature values is greater than or equal to the distance threshold, it indicates that the target object in the target region has no on state of the color corresponding to the reference feature value, i.e., there is no color corresponding to the reference feature value is displayed with high brightness, or no signal indicator light is on.

S32: it is determined that the target object is in the first state in response to presence of a class center matching the reference feature value.

As described above, when there is a class center having a distance to the reference feature value being less than the distance threshold, it can be determined that there is the class center matching the reference feature value. In this case, it can be determined that the target object in the target region is in the first state, i.e., there is the high-brightness display state of the color corresponding to the reference feature value. This indicates that there may be an indicator light that is on.

S33: it is determined that the target object is in the second state in response to absence of a class center matching the reference feature value.

As described above, when the distance between the first feature value of each of the class centers of all class groups and any reference feature value is greater than or equal to the distance threshold, it can be determined that there is no class center matching the reference feature value. In this case, it can be determined that the target object in the target region is in the second state, i.e., there is no high-brightness display state of the color corresponding to the reference feature value. This indicates that no indicator light is on.

S34: the display state of the target object is determined based on the first state or the second state.

In some possible embodiments, when it is determined that the target object is in the second state, the display state of the target object is a state where no color corresponding to any reference feature value is displayed with high brightness, i.e., no signal indicator light is on.

In some possible embodiments, when it is determined that the target object is in the first state, the display state of the target object is a state where the color corresponding to the reference feature value is displayed with high brightness, i.e., no signal indicator light is on.

The first state and the second state of the signal indicator light can be determined according to the embodiment of the present disclosure, wherein in the second state, it can be determined that no signal indicator light in the target region is on. In this case, it can be detected that the signal indicator light here is an indicator light out of order (because in normal condition, one of the signal indicator lights is on). In addition, to remind the relevant authority of the failure of the indicator light, the failure information can be reported in case of determining that the signal indicator light in the target image is in the second state. For example, the target image, the location information corresponding to the target image and the second state of the target image are transmitted together to a preset storage address (the correspondence address of the transport agency) to report the failure information, so that the staff of the relevant authority can inspect and repair the signal indicator light and the traffic safety can be improved.

In addition, the reference feature values corresponding to a plurality of colors in the embodiment of the present disclosure, for example, reference RGB values, can be determined through set RGB values. The RGB value of red color in the standard state can be determined as the reference feature value for red, the RGB value of amber color in the standard state as the reference feature value for amber and the RGB value of green color in the standard state as the reference feature value for green.

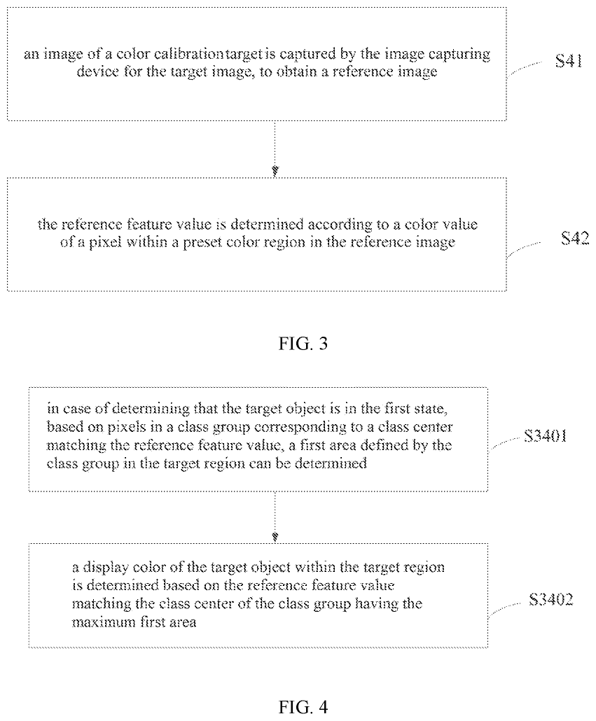

In some other embodiments, an image of a color calibration target can be captured by an image capturing device to obtain the reference feature values of a plurality of colors corresponding to the image capturing device. FIG. 3 shows a flow chart of obtaining a reference feature value in a method for detecting a state of a signal indicator light according to an embodiment of the present disclosure. The obtaining the reference feature value includes steps of:

S41: an image of a color calibration target is captured by the image capturing device for the target image, thereby obtaining a reference image.

In some possible embodiments, the color calibration target can be a color sample having different colors. The reference image for the color calibration target can be obtained by capturing an image of the color calibration target with the image capturing device for the target image.

S42: the reference feature value is determined according to a color value of a pixel within a preset color region in the reference image.

Since the reference image may include a plurality of color regions, the color values (e.g., RGB values) of pixels within the plurality of color regions can be obtained. In the embodiment of the present disclosure, a mean value of the color values of the pixels within a corresponding color region can be taken as the corresponding reference feature value for the color region, i.e., the reference feature value of the color.

Likewise, similar to the manner of obtaining the first feature value, the mean value of the color values of the corresponding color region can be normalized to obtain the reference feature value of the color. The normalization approach is the same as described above. For example, the mean value of the color values is divided by a grayscale or other standard value to obtain a normalized reference feature value, and the specific process is not reiterated here.

According to the above embodiment, the reference values of the image capturing device for a plurality of colors can be obtained, so that subsequent logical processing, i.e., matching of a class center and the reference feature value can be carried out based on the reference feature values in subsequent process. Thus, the influence of the parameters of the image capturing device on the pixels of colors can be reduced. Furthermore, this can be applied to a plurality of types of image capturing devices, so that color deviation between images captured by the image capturing devices can be reduced.

In some possible embodiments, when it is determined that the target object is in the first state, the color of the indicator light that is on can be further determined.

FIG. 4 shows a flow chart of step S34 in a method for detecting a state of a signal indicator light according to an embodiment of the present disclosure, wherein determining the display state of the target object based on the first state or the second state includes steps of:

S3401: in case of determining that the target object is in the first state, based on pixels in a class group corresponding to a class center matching the reference feature value, a first area defined by the class group in the target region can be determined.

In some possible embodiments, in case of determining that the target object is in the first state, the first area of a region defined by the pixels in the class group corresponding to the class center matching the reference feature value within the target region can be obtained. For example, the pixels corresponding to the class center matching the reference feature value can be remapped onto the target region and the first area defined by the pixels of the class group within the target region can be determined. In the embodiment of the present disclosure, the first area can be determined in an integration manner, or in other manners, which is not specifically limited in the present disclosure.

S3402: a display color of the target object within the target region is determined based on the reference feature value matching the class center of the class group having a maximum first area.

Since there may be a plurality of class centers matching the reference feature value, the first area corresponding to at least one class group can be obtained. In this case, the color of the reference feature value corresponding to the class group having the maximum first area which is greater than an area threshold can be determined as the display color of the target object in the target region in the embodiment of the present disclosure. The color of the signal indicator light that is on in the target region can be determined simply and conveniently in this way. The corresponding area threshold can be set as required in the embodiment of the present disclosure, which is not specifically limited in the present disclosure.

Alternatively, in some other embodiments of the present disclosure, further clustering can be performed on a plurality of pixels remapped into the target region to obtain a plurality of new class groups, and the display color of the target object, i.e., the color of the indicator light that is on, can be further determined. The detection accuracy of the display color can be improved in this way.

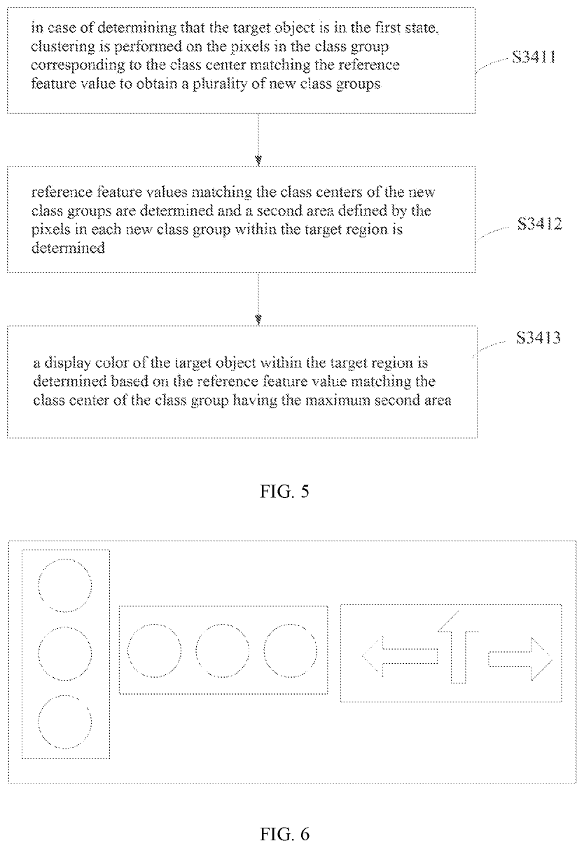

FIG. 5 shows another flow other chart of step S34 in a method for detecting a state of a signal indicator light according to the embodiment of the present disclosure, wherein determining the display state of the target object based on the first state or the second state may further include steps of:

S3411: in case of determining that the target object is in the first state, clustering is performed on the pixels in the class group corresponding to the class center matching the reference feature value to obtain a plurality of new class groups.

As described in the above embodiment, the pixels in the class group corresponding to the determined class center matching the reference feature value can be remapped onto the target region and re-clustering can be performed on the remapped pixels in the embodiment of the present disclosure.

Wherein, similarly, clustering can be performed based on the first feature values of the remapped pixels. For example, K-means clustering can be performed, where the number of clusters set in the clustering in step S20 can be the same as or different from the number of class groups set in the clustering in this step, which can be generally set as a value greater than or equal to 3.

A plurality of new class groups can be obtained after performing the clustering of the remapped pixels based on the first feature values of the remapped pixels. Each new class group may include at least one pixel remapped into the target region. Re-clustering of the pixels in the class matching the reference feature value obtained in step S20 can be realized through this step to form new class groups. On this basis, the class centers of a plurality of new class groups can also be obtained likewise. This process is not specifically limited in the present disclosure.

S3412: reference feature values matching the class centers of the new class groups are determined and a second area defined by the pixels in each new class group within the target region is determined.

S3413: a display color of the target object within the target region is determined based on the reference feature value matching the class center of the class group having a maximum second area.

In some possible embodiments, after a plurality of new class groups are obtained, the reference feature values matching the class centers of the plurality of new class groups can be determined. In this step, the color corresponding to the reference feature value closest to the class center of a new class group can be determined as the color corresponding to the new class group.

Moreover, in this embodiment of the present disclosure, the second area defined by a new class group based on the pixels in the corresponding new class group can also be determined. For example, the region defined by the pixels in a new class group can be determined and a second area of the region can be further determined, i.e., the second area of the corresponding new class group.

After the second areas of the new class groups are obtained, the new class group having the maximum second area can be selected from them. Then, a color corresponding to the reference feature value matching the class center of the new class group having a maximum second area which is greater than an area threshold can be determined as the display color of the target object.

According to the above embodiment, the color of the reference feature value corresponding to the new class group having the maximum second area can be obtained, and the display color can be determined as the display color of the target object. The re-clustering is performed on the pixels in each class group having the matched reference feature value. Since the process of the re-clustering is directed to the pixels in each class group having the matched reference feature value in step S20, the influence on other pixels can be reduced, and the accuracy of each class group obtained by re-clustering and the matching degree of a corresponding color can be improved.

In summary, the embodiment of the present disclosure provides a technical solution for accurately detecting a display state of a signal indicator light detection of a target region, where a plurality of clusters can be obtained by detecting the target region where the target object (the signal indicator light) is present in the image and clustering the feature values of the pixels within the target region where the target object is present, and then the display state of the signal indicator light can be obtained according to the matching of the plurality of class groups with the reference feature values. Through the above clustering, similar pixels having the same display state can be determined as a cluster and the cluster (class group) can be further analyzed accurately to determine the display state of the target object. In this way, the robustness of background interference with the signal indicator light can be improved.

In addition, an embodiment of the present disclosure further provides an intelligent driving control method that can be used in intelligent driving control equipment, for example, in equipment such as an intelligent driving vehicle (including autonomous driving and advanced aided driving systems), a flight vehicle, a robot and a guiding device for the blind. The type of the intelligent driving control equipment is not specifically limited in the present disclosure. Any equipment that can perform driving control in conjunction with the display state of the signal indicator light can be taken as the application subject of the embodiment of the present disclosure.

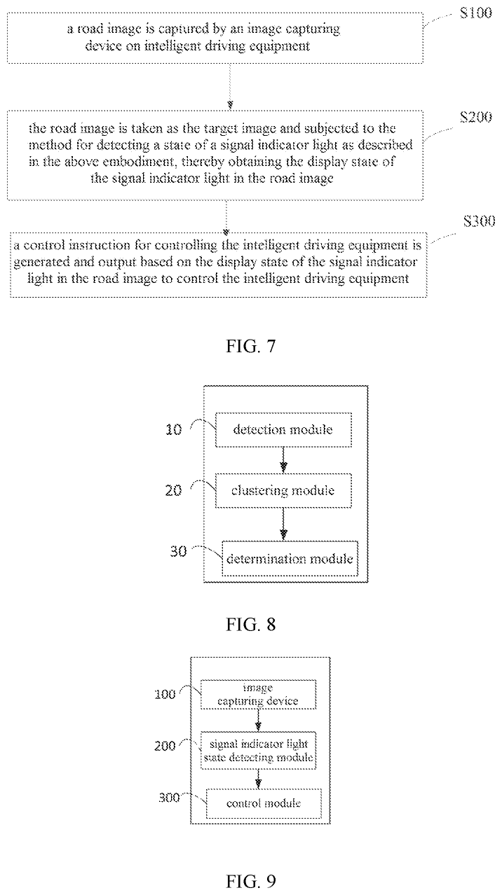

FIG. 7 shows a flow chart of a method for driving control according to an embodiment of the present disclosure, where the method for driving control may include steps of:

S100: a road image is captured by an image capturing device on intelligent driving equipment.

The image capturing device can be disposed in the intelligent driving equipment, which can capture an image of the road ahead of the intelligent driving equipment in real time in the traveling process. Thus, a road image including a signal indicator light can be captured.

S200: the road image is taken as the target image and subjected to the method for detecting a state of a signal indicator light as described in the above embodiment, thereby obtaining the display state of the signal indicator light in the road image.

After the road image is obtained, the display state of the signal indicator light included in the road image can be detected by the method for detecting a state of a signal indicator light. The specific process will not be reiterated here and may refer to the detection process in the above embodiment.

S300: a control instruction for controlling the intelligent driving equipment is generated and output based on the display state of the signal indicator light in the road image to control the intelligent driving equipment.

After obtaining the display state of the signal indicator light included in the road image is obtained, the traveling parameters of the intelligent driving equipment can be controlled based on the display state, i.e., the control instruction for controlling the intelligent driving equipment can be generated. The control instruction may include at least one of: a speed keeping control instruction for keeping a traveling speed, a speed adjusting control instruction for adjusting the traveling speed, a direction keeping control instruction for keeping a traveling direction, a direction adjusting control instruction for adjusting the traveling direction, a warn prompting control instruction for performing warn prompts (e.g., red light warning, and turning warning), and a driving mode switching control instruction. The colors of the reference feature values subjected to clustering may include a red reference feature value, a green reference feature value and an amber reference feature value. For example, after determining that the red light among signal indicator lights is on, slowing down or stopping can be carried out correspondingly. After determining that the green light among signal indicator lights is on, it indicates that going straight is allowed. Alternatively, in other embodiments, at least one of traveling direction determination, lane selection and traveling speed determination can be realized based on the color of the turning indicator light that is on.

According to the above embodiment, the traveling parameters of the intelligent driving equipment can be controlled based on the recognized display state of the signal light. Due to high accuracy of the obtained display state of the signal light, the intelligent driving equipment can be accurately controlled.

It will be understood by a person skilled in the art that in the above methods of the specific embodiments, the description order of different steps does not mean a strict order of execution to be in any way limiting the implementation process, and the specific order of execution of different steps should be determined according to their functions and possible inherent logic.

It will be understood that the foregoing method embodiments as mentioned in the present disclosure can be combined with one another to arrive at combined embodiments without departing from the logic principles, which will not be reiterated here due to limited space. Different embodiments provided in the present disclosure can be combined with one another without departing from the logic.

In addition, the present disclosure further provides an apparatus for detecting a state of a signal indicator light, an apparatus for driving control, an electronic device, a computer readable storage medium, and a program, all of which can be employed to implement any method for detecting a state of a signal indicator light or any method for driving control provided in the present disclosure. For corresponding technical solutions and descriptions, corresponding contents of the method descriptions may be referred to and will not be reiterated here.

FIG. 8 shows a block diagram of an apparatus for detecting a state of a signal indicator light according to an embodiment of the present disclosure. As shown in FIG. 8, the apparatus for detecting a state of a signal indicator light includes:

a detection module 10, configured to detect a target region in a target image and determine first feature values of pixels within the target region, where at least one signal indicator light having different display states is present in the target region;

a clustering module 20, configured to cluster the pixels within the target region based on the first feature values to obtain a plurality of class groups for the pixels; and

a determination module 30, configured to determine a display state of the signal indicator light based on the obtained plurality of class groups.

In some possible embodiments, the determination module is further configured to: determine whether a class center matching a reference feature value preset in an image capturing device that obtains the target image is present according to the reference feature value and the first feature values corresponding to class centers of the class groups; and

determine that the signal indicator light is in a first state in response to presence of the class center matching the reference feature value.

In some possible embodiments, the determination module is further configured to determine that the signal indicator light is in a second state in response to absence of the class center matching the reference feature value after determining whether the class center matching the reference feature value is present according to the reference feature value and the first feature values corresponding to the class centers of the class groups.

In some possible embodiments, the apparatus further includes a setting module, configured to capture an image of a color calibration target with the image capturing device, thereby obtaining a reference image; and

determine the reference feature value according to a color value of a pixel within a preset color region in the reference image.

In some possible embodiments, the setting module is configured to:

capture an image of the color calibration target with the image capturing device, thereby obtaining the reference image;

determine a color value of a pixel within the preset color region as the reference feature value; or normalize a color value of a pixel within the preset color region to obtain the reference feature value.

In some possible embodiments, the reference feature value includes a reference feature value of a red state, a reference feature value of an amber state and a reference feature value of a green state.

In some possible embodiments, the determination module is further configured to: in case of determining that the signal indicator light is in the first state, based on pixels in a class group corresponding to a class center matching the reference feature value, determine a first area defined by the class group in the target region;

determine pixels included in a class group having a maximum first area as the pixels contained by the signal indicator light; and

determine a display color of the signal indicator light within the target region based on the reference feature value matching the class center of the class group having the maximum first area.

In some possible embodiments, the determination module is further configured to: in case of determining that the signal indicator light is in the first state, cluster the pixels in the class group corresponding to the class center matching the reference feature value to obtain a plurality of new class groups;

determine reference feature values matching the class centers of the new class groups and determine a second area defined by the pixels in each new class group within the target region;

determine pixels included in a class group having a maximum second area as the pixels contained by the signal indicator light; and

determine a display color of the signal indicator light within the target region based on the reference feature value matching the class center of the class group having the maximum second area.

In some possible embodiments, the detection module is configured to:

detect a target region in the target image;

determine a color value of a pixel within the target region as the first feature value; or normalize the color value of the pixel within the target region to obtain the first feature value.

In some possible embodiments, the clustering module is configured to: cluster the pixels within the target region by a K-means clustering algorithm to obtain a preset number of class groups.

FIG. 9 shows a block diagram of an apparatus for driving control according to an embodiment of the present disclosure. The apparatus for driving control includes:

an image capturing device 100, mounted on intelligent driving equipment and configured to capture a road image;

a signal indicator light state detecting module 200, configured to subject the road image as the target image to the method for detecting a state of a signal indicator light in the first aspect, thereby obtaining the display state of the signal indicator light in the road image; and

a control module 300, configured to generate and output a control instruction for controlling the intelligent driving equipment based on the display state of the signal indicator light in the road image to control the intelligent driving equipment.

In some possible embodiments, the control instruction may include at least one of: a speed keeping control instruction, a speed adjusting control instruction, a direction keeping control instruction, a direction adjusting control instruction, a warn prompting control instruction, and a driving mode switching control instruction.

In some embodiments, the functions or the modules that the apparatus provided in the embodiment of the present disclosure has can be used to execute the method described in the foregoing method embodiments, and its specific implementation may refer to the description of the foregoing method embodiments, which will not be repeated here for simplicity.

An embodiment of the present disclosure further provides a computer readable storage medium, having computer program instructions thereon, the computer program instructions, when executed by a processor, implementing the foregoing methods. The computer readable storage medium can be a non-volatile computer readable storage medium or a volatile computer readable storage medium.

An embodiment of the present disclosure further provides an electronic device including: a processor; and a memory configured to store processor-executable instructions; wherein the processor is configured to execute the foregoing methods.

An embodiment of the present disclosure further provides a computer program including computer readable codes. When the computer readable codes are running on an electronic device, such codes are executed by the processor of the electronic device to implement the foregoing methods.

The electronic device can be provided as a terminal, a server or a device in other form.

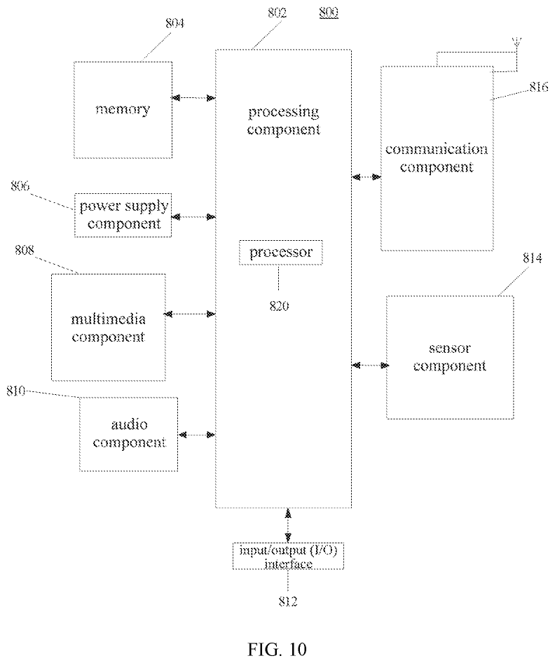

FIG. 10 shows a block diagram of an electronic device according to an embodiment of the present disclosure. For example, the electronic device 800 can be a terminal, such as a mobile phone, a computer, a digital broadcast terminal, a message transceiver, a game console, a tablet device, a medical device, a fitness device, and a personal digital assistant.

Referring to FIG. 10, the electronic device 800 may include one or more of the following components: a processing component 802, a memory 804, a power supply component 806, a multimedia component 808, an audio component 810, an input/output (I/O) interface 812, a sensor component 814, and a communication component 816.

The processing component 802 typically controls the overall operations of the electronic device 800, such as operations associated with display, calling, data communication, camera operations and recording operations. The processing component 802 may include one or more processors 820 for execute instructions to complete all or a part of steps of the foregoing methods. In addition, the processing component 802 may include one or more modules for facilitating interaction between the processing component 802 and other components. For example, the processing component 802 may include a multimedia module for facilitating interaction between the multimedia component 808 and the processing component 802.

The memory 804 is configured to store various types of data to support the operations on the electronic device 800. Examples of such data include instructions of any application program or method operated on the electronic device 800, contact data, telephone directory data, messages, photos, videos, etc. The memory 804 can be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 806 provides power for different components of the electronic device 800. The power supply component 806 may include a power management system, one or more power sources, and other associated component for power generation, management and distribution for the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen can be implemented as a touch screen to receive input signals from the user. The touch panel includes one or more touch sensors to sense touch, slide and gestures on the touch panel. The touch sensor may not only sense the boundary of a touch or slide action, but also detect a duration and pressure associated with the touch or slide action. In some embodiments, the multimedia component 808 includes a front-facing camera and/or rear camera. When the electronic device 800 is in an operating mode, such as a capture mode or a video mode, the front-facing camera and/or rear camera can receive external multimedia data. Each of the front-facing camera and the rear camera can be a fixed optical lens system or have a focal length and optical zooming capability.

The audio component 810 is configured to output and/or input audio signals. For example, the audio component 810 includes a microphone (MIC) configured to receive an external audio signal when the electronic device 800 is in an operating mode, such as a calling mode, a recording mode, and a voice recognition mode. The received audio signal can be further stored on the memory 804 or sent via the communication module 816. In some embodiments, the audio component 810 further includes a speaker for outputting an audio signal.

The I/O interface 812 provides an interface between the processing component 802 and a peripheral interface module. The peripheral interface module can be a keyboard, a click wheel, a button, etc. Such buttons may include, but are not limited to, a home button, a volume button, a start button, and a lock button.

The sensor component 814 includes one or more sensors to provide various aspects of status assessment for the electronic device 800. For example, the sensor component 814 can detect the on/off state of the electronic device 800, and relative positioning of components. For example, the components are a display and a small keyboard of the electronic device 800. The sensor component 814 can also detect the position change of the electronic device 800 or one component of the electronic device 800, the presence or absence of contact between a user and the electronic device 800, the orientation or acceleration/deceleration of the electronic device 800 and the temperature change of the electronic device 800. The sensor component 814 may include a proximity sensor configured to detect presence of a nearby object in the absence of any physical contact. The sensor component 814 may also include an optical sensor, such as a complementary metal oxide semiconductor (CMOS) or charge coupled device (CCD) image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the electronic device 800 and other devices. The electronic device 800 can access a wireless network based on communication standards, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the electronic device 800 can be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic elements for performing the foregoing methods.

In an exemplary embodiment, there is further provided a non-volatile computer readable storage medium or a volatile computer readable storage medium, such as a memory 804 including computer program instructions that can be executed by the processor 820 of the electronic device 800 to accomplish the foregoing methods.

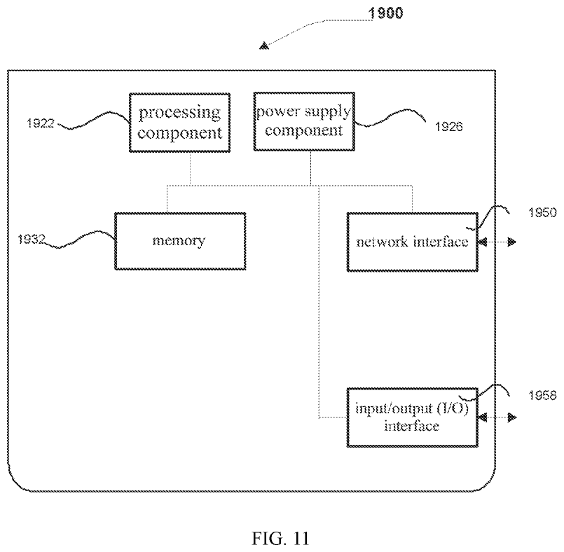

FIG. 11 shows another block diagram of an electronic device according to an embodiment of the present disclosure. The electronic device 1900 can be provided as a server. Referring to FIG. 11, the electronic device 1900 includes a processing component 1922, and further includes one or more processors, and memory resources represented by the memory 1932 for storing instructions that can be executed by the processing component 1922, such as application programs. An application program stored on the memory 1932 may include one or more modules each corresponding to a set of instructions. In addition, the processing component 1922 is configured to execute instructions to perform the foregoing methods.

The electronic device 1900 may also include a power supply component 1926 configured to perform power management for the electronic device 1900, a wired or wireless network interface 1950 configured to connect the electronic device 1900 to the network, and an input/output (I/O) interface 1958. The electronic device 1900 can operate based on an operating system stored on the memory 1932, such as Windows Server™, Mac OS X™, Unix™, Linux™, FreeBSD™ or the like.

In an exemplary embodiment, there is further provided a non-volatile computer-readable storage medium or a volatile computer-readable storage medium, such as a memory 1932 including computer program instructions that can be executed by the processing component 1922 of the electronic device 1900 to accomplish the foregoing methods.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A method for detecting a state of a signal indicator light, comprising:
detecting a target region in a target image and determining first feature values of pixels within the target region, wherein at least one signal indicator light having different display states is included in the target region;
clustering the pixels within the target region based on the first feature values to obtain a plurality of class groups for the pixels; and
determining a display state of the signal indicator light based on the obtained plurality of class groups.

2. The method according to claim 1, wherein determining a display state of the signal indicator light based on the obtained plurality of class groups comprises:
determining whether a class center matching a reference feature value preset in an image capturing device for the target image is present according to the reference feature value and the first feature values corresponding to class centers of the class groups; and
determining that the signal indicator light is in a first state in response to presence of a class center matching the reference feature value.

3. The method according to claim 2, further comprising:
determining that the signal indicator light is in a second state in response to absence of a class center matching the reference feature value, after determining whether a class center matching the reference feature value is present according to the reference feature value and the first feature values corresponding to class centers of the class groups.

4. The method according to claim 2, wherein the reference feature value is set by:
capturing an image of a color calibration target with the image capturing device, to obtain a reference image; and
determining the reference feature value according to a color value of a pixel within a preset color region in the reference image.

5. The method according to claim 4, wherein determining the reference feature value according to a color value of a pixel within a preset color region in the reference image comprises:
determining a color value of a pixel within the preset color region as the reference feature value; or
normalizing a color value of a pixel within the preset color region to obtain the reference feature value.

6. The method according to claim 2, wherein the reference feature value includes a reference feature value of a red state, a reference feature value of an amber state and a reference feature value of a green state.

7. The method according to claim 2, further comprising:
in case of determining that the target object light is in the first state, based on pixels in a class group corresponding to a class center matching the reference feature value, determining a first area defined by the class group in the target region;
determining the pixels included in the class group having the maximum first area as the pixels contained by the signal indicator light; and
determining the display color of the signal indicator light within the target region based on the reference feature value matching the class center of the class group having the maximum first area.

8. The method according to claim 2, further comprising:
in case of determining that the signal indicator light is in the first state, clustering the pixels in the class group corresponding to the class center matching the reference feature value to obtain a plurality of new class groups;
determining reference feature values matching the class centers of the new class groups and determining a second area defined by pixels in each new class group within the target region;
determining pixels included in a class group having a maximum second area as the pixels contained by the signal indicator light; and
determining a display color of the signal indicator light within the target region based on the reference feature value matching the class center of the class group having the maximum second area.

9. The method according to claim 1, wherein determining the first feature values of the pixels within the target region comprises:
determining a color value of a pixel within the target region as the first feature value; or
normalizing the color value of the pixel within the target region to obtain the first feature value.

10. The method according to claim 1, wherein clustering the pixels within the target region based on the first feature values to obtain a plurality of class groups for the pixels comprises:
clustering the pixels within the target region by a K-means clustering algorithm to obtain a preset number of class groups.

11. The method according to claim 1, wherein,
the target image being a road image captured by an image capturing device mounted on intelligent driving equipment; and
the display state is a display state of the signal indicator light in the road image;
the method further comprising:
generating and outputting a control instruction for controlling the intelligent driving equipment based on the display state of the signal indicator light in the road image to control the intelligent driving equipment.

12. The method according to claim 11, wherein the control instruction includes at least one of: a speed keeping control instruction, a speed adjusting control instruction, a direction keeping control instruction, a direction adjusting control instruction, a warn prompting control instruction, and a driving mode switching control instruction.

13. An apparatus for detecting a state of a signal indicator light, comprising:
a processor; and
a memory configured to store processor-executable instructions;
wherein when executed by the processor the instructions cause the processor to:
detect a target region in a target image and determining first feature values of pixels within the target region, wherein at least one signal indicator light having different display states is included in the target region;
cluster the pixels within the target region based on the first feature values to obtain a plurality of class groups for the pixels; and
determine a display state of the signal indicator light based on the obtained plurality of class groups.

14. The apparatus according to claim 13, wherein,
the target image being a road image captured by an image capturing device mounted on intelligent driving equipment; and
the display state is a display state of the signal indicator light in the road image; and
the instructions further cause the processor to:
generate and output a control instruction for controlling the intelligent driving equipment based on the display state of the signal indicator light in the road image to control the intelligent driving equipment.

15. A non-transitory computer readable storage medium having computer program instructions stored thereon, wherein the computer program instructions, when executed by a processor, cause the processor to:
detect a target region in a target image and determining first feature values of pixels within the target region, wherein at least one signal indicator light having different display states is included in the target region;
cluster the pixels within the target region based on the first feature values to obtain a plurality of class groups for the pixels; and
determine a display state of the signal indicator light based on the obtained plurality of class groups.

16. The non-transitory computer readable storage medium according to claim 15, wherein determining a display state of the signal indicator light based on the obtained plurality of class groups comprises:
determining whether a class center matching a reference feature value preset in an image capturing device for the target image is present according to the reference feature value and the first feature values corresponding to class centers of the class groups; and
determining that the signal indicator light is in a first state in response to presence of a class center matching the reference feature value.

17. The non-transitory computer readable storage medium according to claim 16, wherein the instructions further cause the processor to:
determine that the signal indicator light is in a second state in response to absence of a class center matching the reference feature value, after determining whether a class center matching the reference feature value is present according to the reference feature value and the first feature values corresponding to class centers of the class groups.

18. The non-transitory computer readable storage medium according to claim 16, wherein the reference feature value is set by:
capturing an image of a color calibration target with the image capturing device, to obtain a reference image; and
determining the reference feature value according to a color value of a pixel within a preset color region in the reference image.

19. The non-transitory computer readable storage medium according to claim 18, wherein determining the reference feature value according to a color value of a pixel within a preset color region in the reference image comprises:
determining a color value of a pixel within the preset color region as the reference feature value; or
normalizing a color value of a pixel within the preset color region to obtain the reference feature value.

20. The non-transitory computer readable storage medium according to claim 16, wherein the instructions further cause the processor to:
in case of determining that the target object light is in the first state, based on pixels in a class group corresponding to a class center matching the reference feature value, determine a first area defined by the class group in the target region;
determine the pixels included in the class group having the maximum first area as the pixels contained by the signal indicator light; and
determine the display color of the signal indicator light within the target region based on the reference feature value matching the class center of the class group having the maximum first area.
